(19) United States
(12) Patent Application Publication
(10) Pub. No.: US 2010/0246692 A1
(43) Pub. Date: Sep. 30, 2010

(54) FLEXIBLE INTERPOLATION FILTER STRUCTURES FOR VIDEO CODING

(75) Inventors: Dmytro Rusanovskyy, Tampere (FI); Kemal Ugur, Tampere (FI); Antti Olli Hallapuro, Tampere (FI); Jani Lainema, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/630,731

(22) Filed: Dec. 3, 2009

Related U.S. Application Data
(60) Provisional application No. 61/119,699, filed on Dec. 3, 2008.

(51) Int. Cl. H04N 7/26

(52) U.S. Cl. 375/240.29; 375/E07.193

(57) ABSTRACT

Systems and methods of signaling different filter structures for each pixel or sub-pixel position in motion compensation prediction video coding are provided. An encoder signals to a decoder one filter structure among a plurality of pre-defined candidates that is used for a respective pixel or sub-pixel position. In accordance with one embodiment, filter structures signaled to the decoder from the encoder “switch” between directional filter and radial filter structures during interpolation at the sub-pixel level. In accordance with another embodiment, filter structures that are signaled may switch between a directional filter structure and a separable filter structure at the sub-pixel level. Thus, not only can an encoder switch between different filter structures during interpolation, but a filter structure pair is provided that the encoder can utilize to interpolate a wide range of signals without increasing tap-length.

### FIELD

Various embodiments relate generally to video coding. More particularly, various embodiments relate to interpolation and/or filtering processes using adaptive switching for sub-pixel locations in motion-compensated prediction in video coding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video encoder transforms input video into a compressed representation suited for storage and/or transmission. A video decoder uncompresses the compressed video representation back into a viewable form. Typically, the video encoder exploits temporal and spatial redundancies within a sequence of images to reduce the amount of information to represent the video signal. Existing video coding standards, including, e.g., ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), all employ a hybrid coding scheme comprising a motion compensated prediction followed by a prediction error coding process. In motion compensated coding, a matching block is searched in one or more previously coded images. Since the motion of objects in a video sequence is not constrained at integer (or full) pixel locations, an interpolation process is performed on the reference frame to obtain values of the locations “in between” image pixels, i.e., fractional pixels. The interpolation process directly affects the performance of the motion compensated prediction, thereby affecting the compression efficiency. Additionally, the interpolation process is typically achieved by an adaptive interpolation filter. There is a need to design an improved interpolation process for motion compensated prediction in video coding.

### SUMMARY OF VARIOUS EMBODIMENTS

Various embodiments relate to a method of and apparatus comprising an electronic device configured to signal different filter structures, where a filter structure is selected from a plurality of filter structures having a maximal and minimal support area. Coefficient values of a filter are calculated based on the selected filter structure and prediction information indicative of a difference at least between a current frame and a reference frame. The filter coefficient values are encoded in a bitstream, and the filter structure for each of a plurality of at least one of pixel and sub-pixel locations in the bitstream are signaled.

Various embodiments also relate to a method of and apparatus comprising an electronic device configured to decode a bitstream. Filter coefficient values and at least one signal representative of a filter structure selected from a plurality of filter structures for each of a plurality of samples interpolated from at least one of pixel and sub-pixel locations of a block representative of prediction information are received. A filter for each of the plurality of samples based on the received filter structure for each of the plurality of samples and the received filter coefficient values is calculated. A prediction frame based on the prediction information and the plurality of samples is then reconstructed.

Various embodiments increase the coding efficiency of video coders, without increasing the decoding complexity. That is, not only can various embodiments switch between different filter structures during interpolation, but a filter structure pair is provided that the encoder can utilize to interpolate a wide range of signals without increasing tap-length.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 is a block diagram of a conventional video encoder;

FIG. 2 illustrates an exemplary inter prediction process;

FIG. 3 is a representation showing a pixel/sub-pixel arrangement including a specified pixel/sub-pixel notation;

FIG. 4 is a block diagram of a conventional video decoder;

FIGS. 5a-5e illustrate examples of a directional interpolation filter structure;

FIGS. 6a-6c illustrate examples of a radial interpolation filter structure;

FIG. 7a illustrates an example of an image change in a diagonal direction with diagonal cross filter support;

FIG. 7b illustrates an exemplary frequency response (cut-off frequencies) of a 12-tap diagonal cross filter;

FIG. 7c illustrates an exemplary frequency response (cut-off frequencies) comparison of 2D 12-tap and 36-tap filters;

FIGS. 8a-8f illustrate examples of different interpolation filter structure pairs having maximal and minimal spatial support areas for a given tap-length;

FIGS. 9a-9f illustrate examples of a flexible filter structure unifying the directional and radial interpolation filter structures of FIGS. 2a-2e and 3a-3c;

FIG. 10 is a flow chart illustrating exemplary processes performed for signaling different filter structures in accordance with various embodiments

FIG. 11 is an overview diagram of a system within which various embodiments of the present invention may be implemented;

FIG. 12 is a perspective view of an electronic device that can be used in conjunction with the implementation of various embodiments of the present invention; and

FIG. 13 is a schematic representation of the circuitry which may be included in the electronic device of FIG. 12.

### DETAILED DESCRIPTION OF VARIOUS EMBODIMENTS

Various embodiments provide systems and methods of signaling different filter structures for each sub-pixel position in MCP video coding. For each sub-pixel position, potential (pre-defined) filter structure candidates are known to both the encoder and the decoder. The encoder signals to the decoder, preferably at a slice level, one filter structure among the pre-defined candidates that is used for a respective sub-pixel position. In accordance with one embodiment, filter structures signaled to the decoder from the encoder “switch” between directional filter and radial filter structures during interpolation at the sub-pixel position level. In accordance with another embodiment, filter structures that are signaled may switch between a directional filter structure and a separable filter structure at the sub-pixel position level.

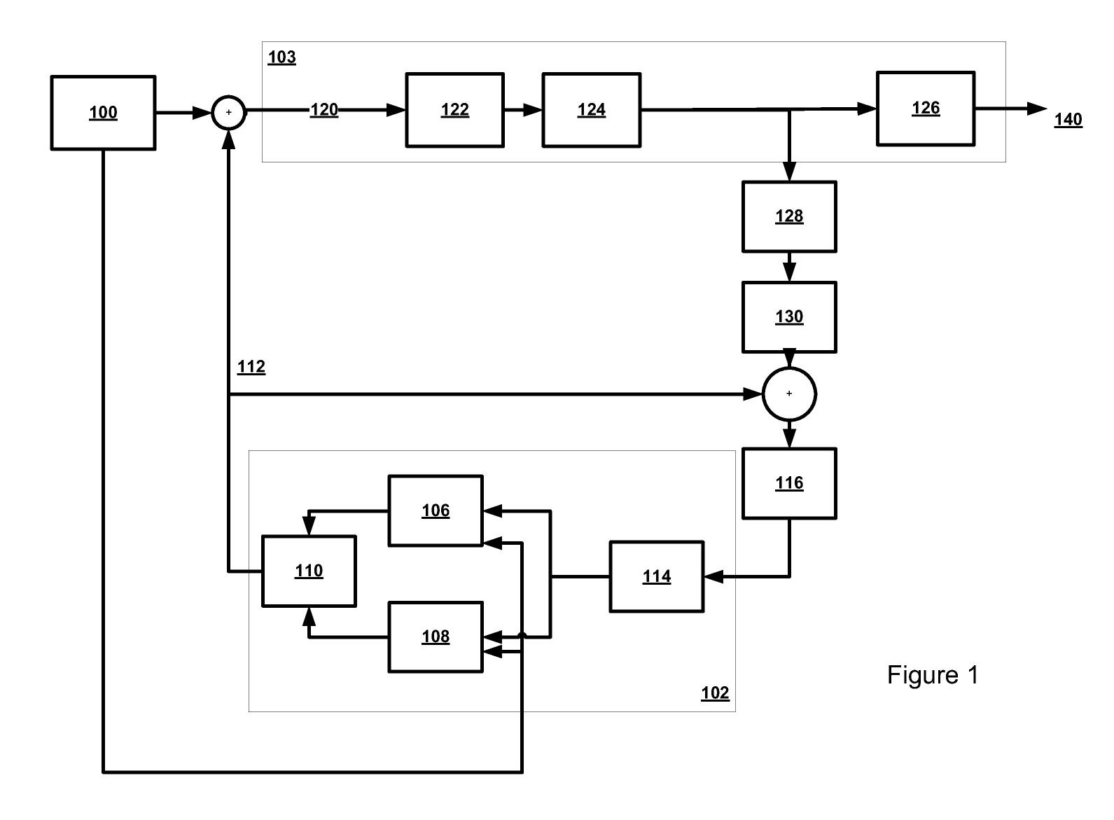

FIG. 1 is a block diagram of a conventional video encoder. Typically, an input image is divided into blocks and each block undergoes the operations as depicted in FIG. 1. More particularly, FIG. 1 shows how an image block to be encoded 100 undergoes pixel prediction 102 and prediction error coding 103. For pixel prediction 102, the image 100 undergoes either an inter-prediction 106 process, an intra-prediction 108 process, or both. Mode selection 110 selects either one of the inter-prediction and the intra-prediction to obtain a predicted block 112. The predicted block 112 is then subtracted from the original image 100 resulting in a prediction error, also known as a prediction residual 120. In intra-prediction 108, previously reconstructed parts of the same image 100 stored in frame memory 114 are used to predict the present block. In inter-prediction 106, previously coded images stored in frame memory 114 are used to predict the present block. In prediction error coding 103, the prediction error/residual 120 initially undergoes a transform operation 122. The resulting transform coefficients are then quantized at 124.

The quantized transform coefficients from 124 are entropy coded at 126. That is, the data describing prediction error and predicted representation of the image block 112 (e.g., motion vectors, mode information, and quantized transform coefficients) are passed to entropy coding 126. The encoder typically comprises an inverse transform 130 and an inverse quantization 128 to obtain a reconstructed version of the coded image locally. Firstly, the quantized coefficients are inverse quantized at 128 and then an inverse transform operation 130 is applied to obtain a coded and then decoded version of the prediction error. The result is then added to the prediction 112 to obtain the coded and decoded version of the image block. The reconstructed image block may then undergo a filtering operation 116 to create a final reconstructed image 140 which is sent to a reference frame memory 114. The filtering may be applied once all of the image blocks are processed.

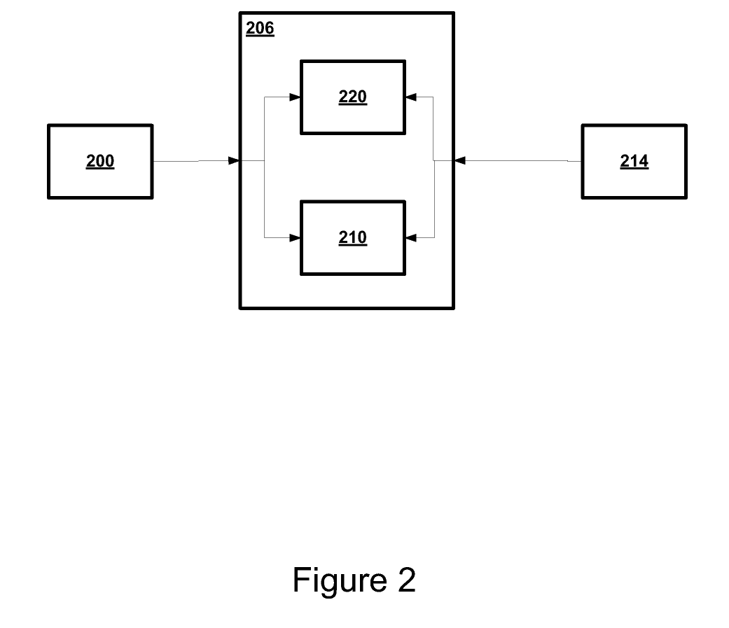

FIG. 2 illustrates an exemplary inter prediction process 206 for an input image 200. In motion estimation block 210, a matching block is searched in one or more previously coded images stored in reference frame memory 214. The motion of the block is represented by a motion vector. Each of these motion vectors represents the displacement of the image block in the picture to be coded (in the encoder side) or decoded (in the decoder side) relative to the prediction source block in one of the previously coded or decoded pictures. In general, the motion of objects in a video sequence is not constrained at integer (or full) pixel locations and therefore, the motion vectors are not limited to having full-pixel accuracy, but could have fractional-pixel (pel) accuracy as well. That is, motion vectors can point to fractional-pixel positions/locations of the reference frame, where the fractional-pixel locations can refer to, for example, locations “in between” image pixels. In order to obtain samples at fractional-pixel locations, an interpolation process 220 is performed. Interpolation process is typically achieved by using an interpolation filter. For example, in MPEG-2, motion vectors can have at most, half-pixel accuracy, where the samples at half-pixel locations are obtained by a simple averaging of neighboring samples at full-pixel locations.

Another example is the H.264/AVC video coding standard supporting motion vectors with up to quarter-pixel accuracy. Furthermore, in the H.264/AVC video coding standard, half-pixel samples are obtained through the use of symmetric and separable 6-tap filters, while quarter-pixel samples are obtained by averaging the nearest half or full-pixel samples.

The coding efficiency of a video coding system can be improved by adapting the interpolation filter coefficients at each frame so that the non-stationary properties of the video signal are more accurately captured. In this approach, the video encoder transmits the filter coefficients as side information to the decoder. The encoder is then able to change the filter coefficients at a frame/slice or macroblock level by analyzing the video signal. The decoder uses the received filter coefficients rather than a predefined filter in the MCP process.

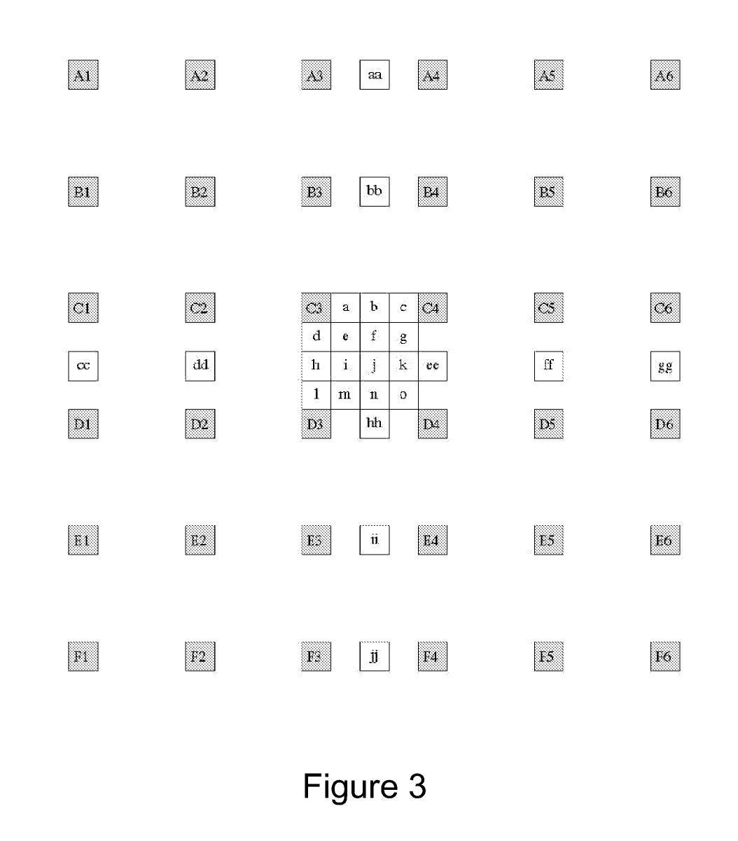

Another system may involve using two-dimensional non-separable 6×6-tap Wiener adaptive interpolation filters (2D-AIF). Typically, the use of an adaptive interpolation filter requires two encoding passes for each coded frame. During the first encoding pass, which is performed with the standard H.264 interpolation filter, motion predication information is collected. Subsequently, for each fractional quarter-pixel position, an independent filter is used and the coefficients of each filter are calculated analytically by minimizing the prediction-error energy. FIG. 3, for example, shows a number of example quarter-pixel positions, identified as {a}-{o}, positioned between individual full-pixel positions {C3}, {C4}, {D3} and {D4}. After the coefficients of the adaptive filter are found, the reference frame is interpolated with this filter and the frame is encoded.

Current conventional adaptive interpolation schemes use a pre-defined filter structure to obtain each sample instead of adapting the filter structure to the characteristics of the frame at issue. For example, the above-described system that utilizes the 2D-AIF uses a 1D filter for horizontally and vertically aligned sub-pixel positions and the 2D non-separable filter for other sub-pixel positions. Similarly, an adaptive interpolation scheme may use directional filters, where 1D directional filters are utilized for diagonally aligned sub-pixel positions and cross-diagonal filters are used for non-aligned sub-pixel positions.

However, the use of a fixed filter structure may not be optimal for all types of input video signals because the signal characteristics of the different types of input video signals may vary significantly.

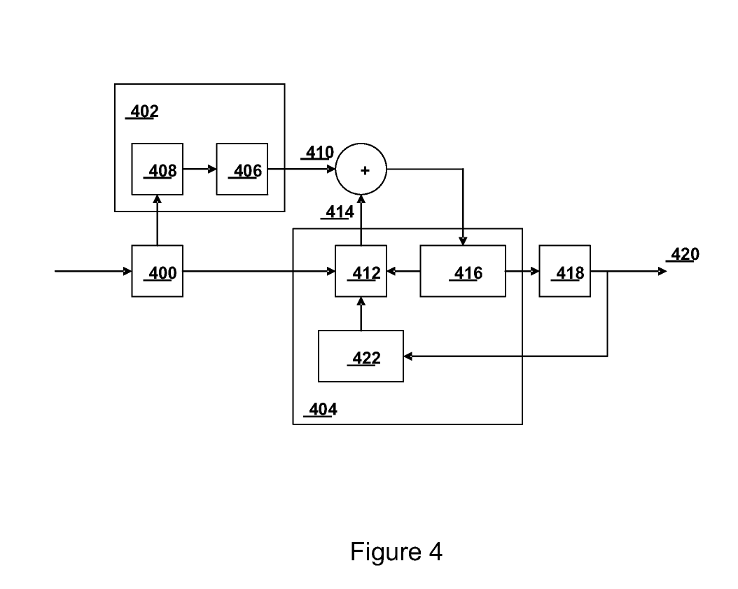

FIG. 4 is a block diagram of a conventional video decoder. As shown in FIG. 4, entropy decoding 400 is followed by both prediction error decoding 402 and pixel prediction 404. In prediction error decoding 402, an inverse quantization 406 and inverse transform 408 is used, ultimately resulting in a reconstructed prediction error signal 410. For pixel prediction 404, either intra-prediction or inter-prediction occurs at 412 to create a predicted representation of an image block 414. The predicted representation of the image block 414 is used in conjunction with the reconstructed prediction error signal 410 to create a preliminary reconstructed image 416, which in turn can be used for inter-prediction or intra-prediction at 412. Filtering 418 may be applied either after the each block is reconstructed or once all of the image blocks are processed. The filtered image can either be output as a final reconstructed image 420, or the filtered image can be stored in reference frame memory 422, making it usable for prediction 412.

The decoder reconstructs output video by applying prediction mechanisms that are similar to those used by the encoder in order to form a predicted representation of the pixel blocks (using motion or spatial information created by the encoder and stored in the compressed representation). Additionally, the decoder utilizes prediction error decoding (the inverse operation of the prediction error coding, recovering the quantized prediction error signal in the spatial pixel domain). After applying the prediction and prediction error decoding processes, the decoder sums up the prediction and prediction error signals (i.e., the pixel values) to form the output video frame. The decoder (and encoder) can also apply additional filtering processes in order to improve the quality of the output video before passing it on for display and/or storing it as a prediction reference for the forthcoming frames in the video sequence.

That is and in light of the above, not only can various embodiments switch between different filter structures during interpolation, but importantly, a filter structure pair is provided that the encoder can utilize to interpolate a wide range of signals without increasing tap-length. It should be noted that although various embodiments herein are described in the context of interpolation, various embodiments can be implemented to/for any type of filtering application.

As discussed previously, FIG. 3 denotes a series of sub-pixel positions {a}-{o} to be interpolated between pixels {C3}, {C4}, {D3} and {D4}, with interpolation being performed up to the quarter pixel level. Samples at each of the sub-pixel positions may be generated in accordance with a particular interpolation filter structure, where a “filter structure” refers to a set of integer pixel samples that is used to obtain each sub-pixel sample in interpolation.

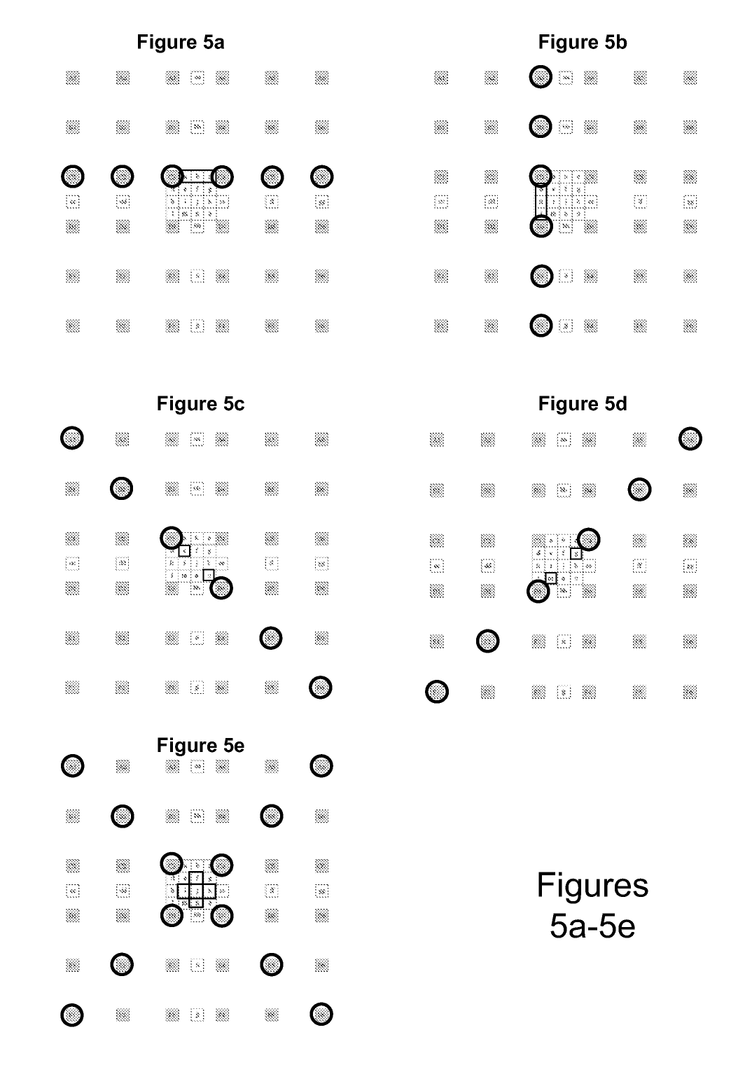

FIGS. 5a-5e illustrate examples of a directional interpolation filter structure that encompasses one-dimensional (1D) horizontal, vertical and diagonal filters, as well as a diagonal cross (sparse 2D) filter. Referring to FIGS. 5a and 5b, samples at each of the sub-pixel positions are generated with independent pixel-aligned one-dimensional (1D) interpolation filters. For example, sub-pixel samples which are horizontally or vertically aligned with integer pixels positions, for example the samples at positions {a}, {b}, and {c} in FIG. 5a, and the samples at positions {d}, {h} and {l} in FIG. 5b, are computed with 1D horizontal or vertical adaptive filters, respectively. Assuming the utilized filter is 6-tap, this is indicated as follows:
{a,b,c}=fun (C1,C2,C3,C4,C5,C6)
{d,h,l}=fun (A3,B3,C3,D3,E3,F3)

In other words, each of the values of {a}, {b} and {c} is a function of {C1}-{C6} in this example.

Referring to FIGS. 5c and 5d, samples at each of the sub-pixel positions are generated with 1D directional (diagonal) interpolation filters. For example, sub-pixel samples {e}, {g}, {m} and {o} are diagonally aligned with integer pixel positions. Interpolation filters for {e} and {o} utilize image pixels that are diagonally aligned in the northwest-southeast (NW-SE) direction as illustrated in FIG. 5c. Sub-pixel samples {m} and {g} are diagonally aligned in the northeast-southwest (NE-SW) direction as illustrated in FIG. 5d. If 6-tap filtering is assumed, then the filtering operations for these sub-pixel locations are indicated as follows:
{e,o}=fun (A1,B2,C3,D4,E5,F6),
{m,g}=fun (F1,E2,D3,C4,B5,A6)

Referring to FIG. 5e, samples at sub-pixel positions are generated with a diagonal cross interpolation filter. For example, sub-pixel samples {f}, {i}, {j}, {k}, and {n} are aligned with respect to a diagonal cross of integer pixel positions. The diagonal cross filters represent filters having the maximum support area for a given tap-length. Assuming a 12-tap filter span, filtering operations for these sub-pixel locations are indicated as follows:
{f, i, j, k, n}=fun (A1,B2,C3,D4,E5,F6,F1,E2,D3,C4,B5,A6)

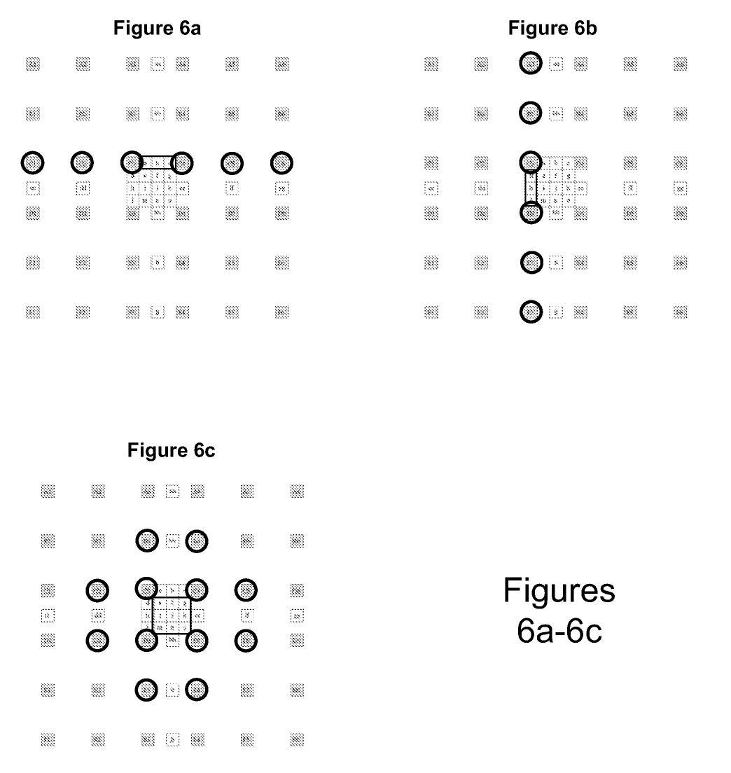

FIGS. 6a-6c illustrate examples of a radial interpolation filter structure that like the directional interpolation filter structure supports one-dimensional (1D) filtering, but instead of directional/diagonal filters, includes a radial filter structure to obtain sub-pixel samples that are not horizontally or vertically aligned with integer pixels. Referring to FIGS. 6a and 6b, samples at each of the sub-pixel positions are generated with independent pixel-aligned one-dimensional (1D) interpolation filters. For example, sub-pixel samples which are horizontally or vertically aligned with integer pixels positions, for example the samples at positions {a}, {b}, and {c} in FIG. 6a, and the samples at positions {d}, {h} and {l} in FIG. 6b, are computed with 1D horizontal or vertical adaptive filters, respectively. Assuming the utilized filter is 6-tap, this is indicated as follows:
{a,b,c}=fun (C1,C2,C3,C4,C5,C6)
{d,h,l}=fun (A3,B3,C3,D3,E3,F3)

In other words, each of the values of {a}, {b} and {c} is a function of {C1}-{C6} in this example.

FIG. 6c illustrates the radial interpolation filter structure. For example, a filter with such a structure can be applied to interpolate samples at a central point with respect to a span of integer pixel positions and sub-pixel locations {f,i,j,k,n}. The radial filter structure represents filters having the minimal support area for a given tap-length. That is, assuming a 12-tap filter span, filtering operations for these sub-pixel locations are indicated as follows:
{f, i, j, k, n}=fun (B3,B4,C2,C3,C4,C5,D2,D3,D4,D5,E3,E4)

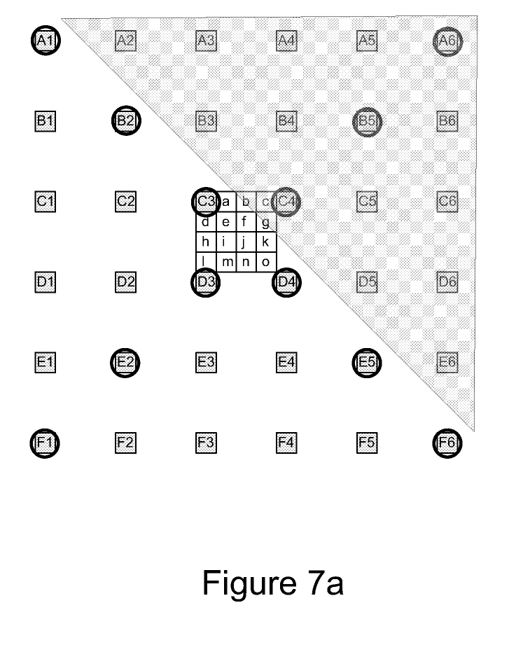

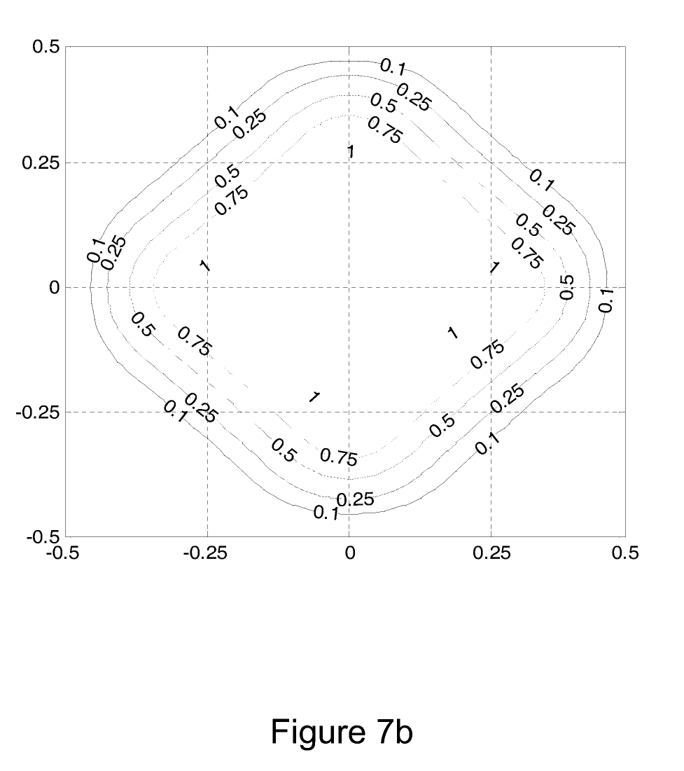

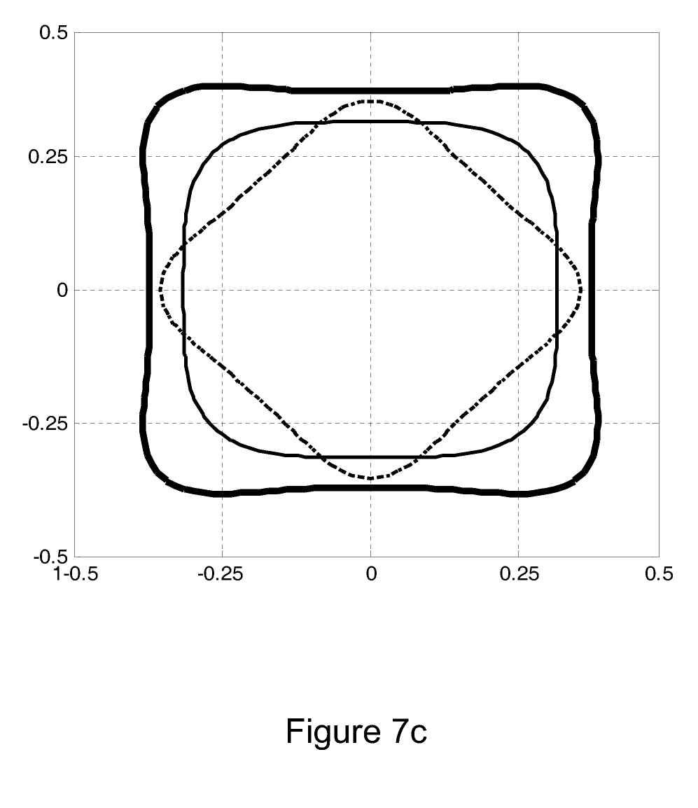

Comparing the diagonal cross/directional and radial filter structures for {f}, {i}, {j}, {k}, and {n} sub-pixel locations, spatial support of the diagonal cross filter provides the largest possible span for any 12-tap filter span (symmetrical for sub-pixels) in the vertical and horizontal directions because the diagonal cross/directional filter spans both sides of a horizontal and vertical edge. That is, an adaptive filter using the diagonal cross filter support is able to capture signal changes in horizontal and vertical directions. However, the diagonal cross filter has “weaker” properties when it comes to supporting signal changes in the diagonal directions. For example, FIG. 7a illustrates an example of an image change in a diagonal direction with diagonal cross filter support. If there is a diagonal edge from the NW-SE direction, only six coefficients of the diagonal cross filter span both sides of the diagonal edge, while the other six coefficients will observe no change. Thus, an adaptive filter with this type of support will not be able to capture diagonal edge information as accurately, and hence cannot minimize the prediction error. It should be noted that this phenomenon can also be observed from a frequency response perspective, where the diagonal cross filter frequency response has much lower cut-off frequency in the diagonal directions when compared to the cut-off frequency in the vertical and horizontal directions. FIG. 7b illustrates this phenomenon by indicating an exemplary frequency response of a 12-tap diagonal cross filter (measured in, e.g., radians), where vertical frequency is plotted along the vertical axis and horizontal frequency is plotted along the horizontal axis.

In contrast with the diagonal cross filter, the radial filter provides the smallest possible span (symmetrical for sub-pixels) in the vertical and horizontal directions for any 12-tap filter (i.e., radial support). Due to this characteristic, the radial filter cannot match the diagonal-cross filter in support of image changes in the horizontal and vertical directions. However, the radial filter provides better support for image changes that occur in diagonal directions, as illustrated, for example, in FIG. 7c. FIG. 7c illustrates an exemplary frequency response (cut-off frequencies) of 2D 12-tap and 36-tap filters. The thicker solid line is indicative of the frequency response of a standard 2D 6×6 filter of H.264/AVC. The thinner solid line indicates the frequency response estimate of a 12-tap radial filter. The thinner dash-dotted line indicates and estimated frequency response of a diagonal-cross filter. Thus, it can be seen that the cut-off frequency of a 12-tap diagonal-cross filter in the horizontal and vertical directions are “close” to that of the standard 6×6 tap H.264/AVC filter. However, where its performance is “weaker” (as described above) for diagonal frequencies, the performance of the 12-tap radial filter can compensate. As with FIG. 7b, vertical frequency is plotted along the vertical axis and horizontal frequency is plotted along the horizontal axis.

Therefore, and in accordance with various embodiments, an encoder is allowed to switch between a complementary filter pair, e.g., the diagonal cross/directional and radial filters, one having a maximal support area and the other having minimal support area for a given tap-length. That is, for a given tap-length, the diagonal cross/directional filter has the largest filter span and offers the highest frequency resolution along with poor spatial resolution, while the radial filter has a smaller filter span offering poorer frequency resolution but the highest spatial resolution. Hence, by switching between these two types of filters, efficient interpolation is achieved for a wide range of signals without increasing the tap-length.

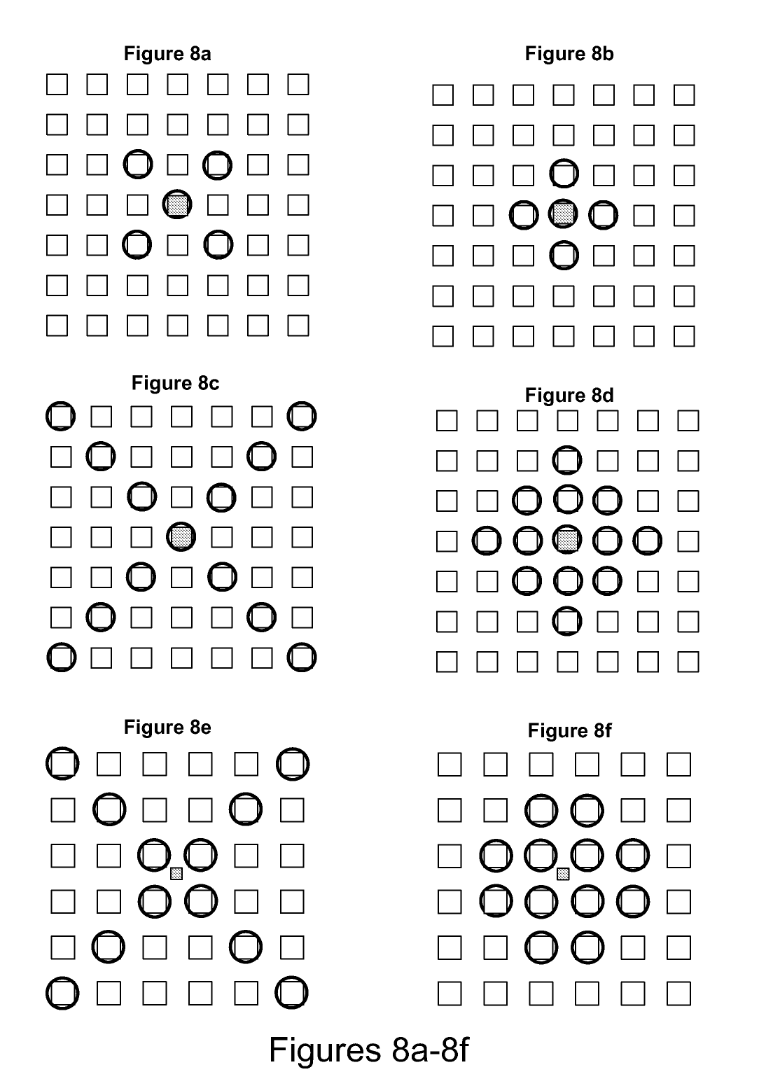

FIGS. 8a-8f illustrate examples of different interpolation filter structure pairs having maximal and minimal spatial support areas for a given tap-length. FIGS. 8e and 8f illustrate interpolation of the shaded sub-pixel by 12 taps using a diagonal filter structure and a radial filter structure, respectively.

It should be noted that as described above, various embodiments can be utilized not only for interpolation, but for efficient filtering for various purposes such as, e.g., deblocking or noise removal. In these cases, switching between a directional/diagonal cross and radial filter is used to filter full-pixel samples. FIG. 8a illustrates filtering a shaded full pixel with 5 taps using a diagonal/direction filter structure. FIG. 8b illustrates a radial filter structure for filtering the same full-pixel with 5 taps. FIGS. 8c and 8d illustrate filtering of the shaded full-pixel by 13 taps using a diagonal filter and a radial filter, respectively.

In accordance with various embodiments, one or more combinations between the aforementioned directional and radial filter structures are pre-defined and may be sent to a decoder to allow the decoder to obtain samples at the respective sub-pixel positions using the received filter structures. One such pre-defined combination of different filter structures is described below in Table 1.

TABLE 1
Directional Filters

| Sub-Pixel Position | Filter Structure |
|---|---|
| a, b, c, d, h, l | 1D horizontal/vertical filters |
| e, g, m, o | 1D diagonal filter |
| f, i, j, k, n | diagonal-cross filter |

Another pre-defined combination of different filter structures is presented in Table 2.

TABLE 2
Radial Filter

| Sub-Pixel Position | Filter Structure |
|---|---|
| a, b, c, d, h, l | 1D horizontal/vertical filters |
| e, g, m, o | 1D diagonal filter |
| f, i, j, k, n | radial filter |

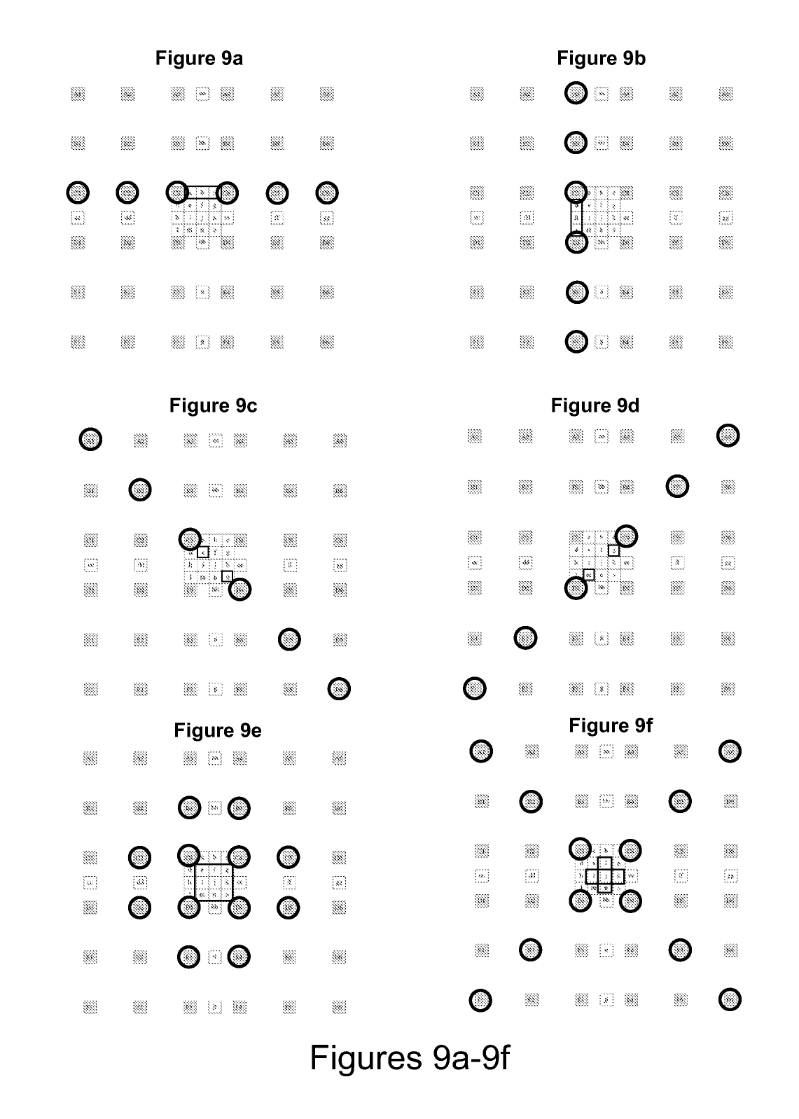

As described above, various embodiments enable a video coder to adapt/select which one of, e.g., two filter structures, is used for each sub-pixel sample. For example a filter structure illustrated in FIGS. 9a-9f unifies the directional and radial interpolation filter structures described above. Thus, an encoder could signal the following filter structures to the decoder.

Sub-pixels a, b, c, d, h, l: Directional
Sub-pixels e, g, m, o: Directional
Sub-pixels f, i, j, k, n: Radial

The flexibility provided in various embodiments provides an encoder with more choices to capture underlying, non-stationary video signal characteristics more accurately. This translates into coding efficiency gains in comparison to using fixed filter structures as is done with conventional systems and methods.

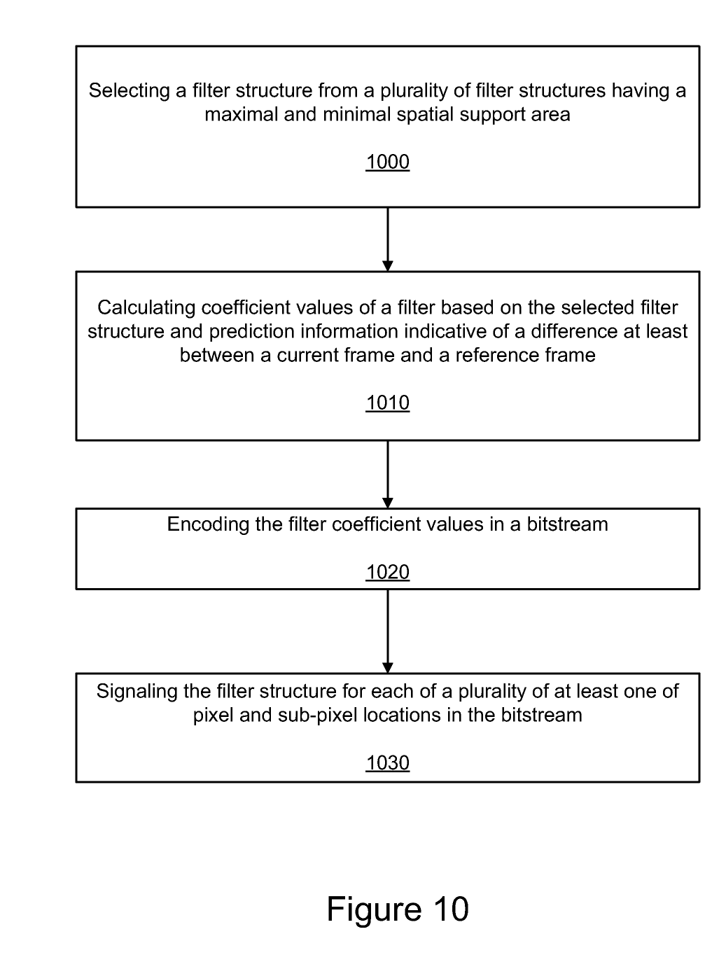

FIG. 10 is a flow chart illustrating exemplary processes performed for signaling different filter structures in accordance with various embodiments. At 1000, a filter structure is selected from a plurality of filter structures having a maximal and minimal support area. At 1010, filter coefficient values of a filter are calculated based on the selected filter structure and prediction information indicative of a difference at least between a current frame and a reference frame. At 1020, the filter coefficient values are encoded in a bitstream. At 1030, the filter structure for each of a plurality of at least one of pixel and sub-pixel locations in the bitstream are signaled. It should be noted that more or less processes may be performed as contemplated by various embodiments. Moreover, it should be noted that the above-described processes may be performed in differing order in accordance with various embodiments.

Generally, no restrictions exist with respect to the encoder-side algorithms for filter structure selection. In accordance with various embodiments, different encoder algorithms may be implemented and utilized to effectively calculate a desired filter structure. Exemplary implementations of a hybrid video encoder with adaptive interpolation capabilities are given described below.

In accordance with one embodiment, a first exemplary algorithm for video coding with adaptive interpolation filters (AIF) and motion prediction error-based structure selection assumes a two-pass hybrid video encoding scheme. With a first pass, motion prediction information is collected using a static interpolation filter. Adaptive interpolation filters with pre-defined structures are computed. The encoder interpolates reference frames with all pre-defined candidate filter structures. Prior to a second coding pass, motion prediction error is computed for each sub-pixel over the reference frames interpolated with different filter structures. The filter structure that produces minimal prediction error is selected for each sub-pixel individually and flagged in the encoded bit-stream. The second coding pass is performed with reference frames which have been interpolated using the selected filter structures. This particular algorithm may increase encoding complexity when compared to conventional coding schemes by the use of additional interpolation and motion compensation modules. The absolute measure of the increase in complexity is dependent upon the number of reference frames and the number of predefined filter structures considered. Nevertheless, MCP-based encoding algorithms are generally assumed to be fast encoding algorithms.

In accordance with another embodiment, a second exemplary algorithm for video coding with AIF and filter coefficients domain-based structure selection assumes a 2D AIF with a support area wide enough to cover all predefined filter structures. It should be noted that a pre-defined filter structure that approximates retrieved 2D-filters coefficients surface with higher accuracy is more appropriate for a current video signal. With a first pass, motion prediction information is collected using a static interpolation filter. Independently for each sub-pixel position, an adaptive 2D wide-support interpolation filter is computed. Analyzing the filter coefficients distribution for each sub-pixel location using the 2D wide-support interpolation filter, a filter structure that approximates the surface of the 2D filter coefficients with higher accuracy is selected, e.g., preserving the maximum of coefficients energy. A filter with the selected filter structure is computed independently for each sub-pixel location. A second coding pass is performed with reference frames that have been interpolated using the selected filter structures. This second exemplary algorithm does not require any additional encoding or interpolation stages when compared to prior art schemes described above, and the increase in complexity is considered insignificant.

In accordance with yet another embodiment, a third exemplary algorithm for video coding with AIF and filter coefficients domain-based structure selection utilizes more than two passes to code each frame. During a first pass, motion prediction information is collected using a static interpolation filter. Adaptive interpolation filters with pre-defined structures are computed. The encoder encodes the frame with all pre-defined candidate filter structures. Prior to the final coding pass, the filter structure that produces minimal rate distortion cost is selected. The final coding pass is performed with reference frames which have been interpolated using the selected filter structures. This particular algorithm may increase encoding complexity when compared to conventional coding schemes by the use of additional interpolation and motion compensation modules. The absolute measure of the increase in complexity is dependent upon the number of reference frames and the number of predefined filter structures considered.

In accordance with still other embodiments, for each sub-pixel sample, a different number of candidate filter structures (e.g., 1, 2, 3, etc.) can be considered. Different filter structures, such as separable and non-separable filters can also be utilized in conjunction with various embodiments. Moreover and in addition to adaptive interpolation filtering, various embodiments can be used in conjunction with non-adaptive filters, in which case each sub-pixel is associated with a fixed set of coefficients.

Various embodiments increase the coding efficiency of video coders, without increasing the decoding complexity. Although encoding complexity may in some instances, be slightly increased by choosing between different candidate filter structures, efficient algorithms exist that decrease the overall encoding complexity.

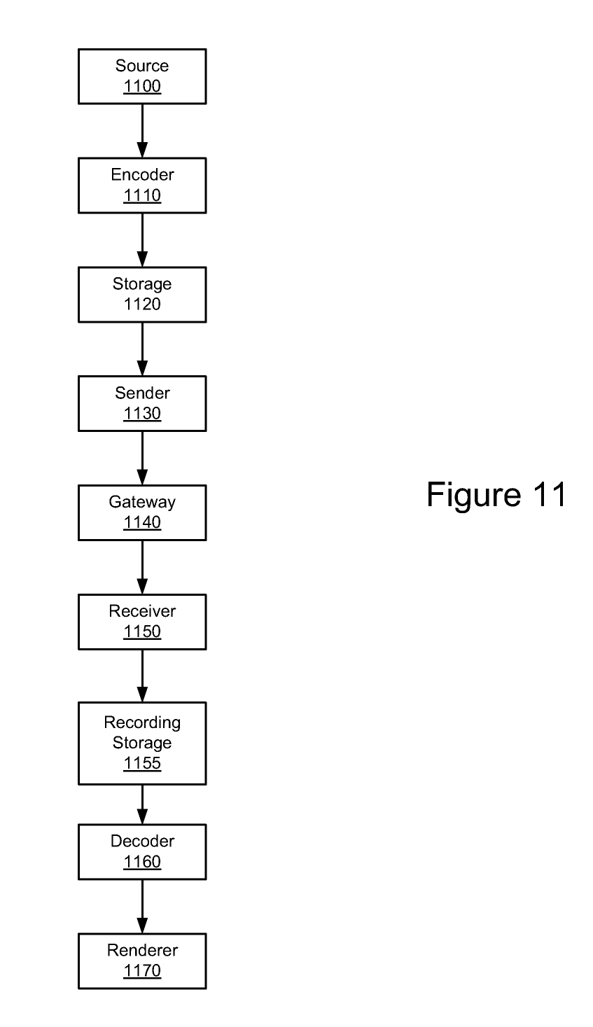

FIG. 11 is a graphical representation of a generic multimedia communication system within which various embodiments of the present invention may be implemented. As shown in FIG. 11, a data source 1100 provides a source signal in an analog, uncompressed digital, or compressed digital format, or any combination of these formats. An encoder 1110 encodes the source signal into a coded media bitstream. It should be noted that a bitstream to be decoded can be received directly or indirectly from a remote device located within virtually any type of network. Additionally, the bitstream can be received from local hardware or software. The encoder 1110 may be capable of encoding more than one media type, such as audio and video, or more than one encoder 1110 may be required to code different media types of the source signal. The encoder 1110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 11 only one encoder 1110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 1120. The storage 1120 may comprise any type of mass memory to store the coded media bitstream. The format of the coded media bitstream in the storage 1120 may be an elementary self-contained bitstream format, or one or more coded media bitstreams may be encapsulated into a container file. Some systems operate “live”, i.e. omit storage and transfer coded media bitstream from the encoder 1110 directly to the sender 1130. The coded media bitstream is then transferred to the sender 1130, also referred to as the server, on a need basis. The format used in the transmission may be an elementary self-contained bitstream format, a packet stream format, or one or more coded media bitstreams may be encapsulated into a container file. The encoder 1110, the storage 1120, and the server 1130 may reside in the same physical device or they may be included in separate devices. The encoder 1110 and server 1130 may operate with live real-time content, in which case the coded media bitstream is typically not stored permanently, but rather buffered for small periods of time in the content encoder 1110 and/or in the server 1130 to smooth out variations in processing delay, transfer delay, and coded media bitrate.

The server 1130 sends the coded media bitstream using a communication protocol stack. The stack may include, but is not limited to, Real-Time Transport Protocol (RTP), User Datagram Protocol (UDP), and Internet Protocol (IP). When the communication protocol stack is packet-oriented, the server 1130 encapsulates the coded media bitstream into packets. For example, when RTP is used, the server 1130 encapsulates the coded media bitstream into RTP packets according to an RTP payload format. Typically, each media type has a dedicated RTP payload format. It should be again noted that a system may contain more than one server 1130, but for the sake of simplicity, the following description only considers one server 1130.

The server 1130 may or may not be connected to a gateway 1140 through a communication network. The gateway 1140 may perform different types of functions, such as translation of a packet stream according to one communication protocol stack to another communication protocol stack, merging and forking of data streams, and manipulation of data streams according to the downlink and/or receiver capabilities, such as controlling the bit rate of the forwarded stream according to prevailing downlink network conditions. Examples of gateways 1140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 1140 is called an RTP mixer or an RTP translator and typically acts as an endpoint of an RTP connection.

The system includes one or more receivers 1150, typically capable of receiving, de-modulating, and de-capsulating the transmitted signal into a coded media bitstream. The coded media bitstream is transferred to a recording storage 1155. The recording storage 1155 may comprise any type of mass memory to store the coded media bitstream. The recording storage 1155 may alternatively or additively comprise computation memory, such as random access memory. The format of the coded media bitstream in the recording storage 1155 may be an elementary self-contained bitstream format, or one or more coded media bitstreams may be encapsulated into a container file. If there are many coded media bitstreams, such as an audio stream and a video stream, associated with each other, a container file is typically used and the receiver 1150 comprises or is attached to a container file generator producing a container file from input streams. Some systems operate “live,” i.e., omit the recording storage 1155 and transfer coded media bitstream from the receiver 1150 directly to the decoder 1160. In some systems, only the most recent part of the recorded stream, e.g., the most recent 10-minute excerption of the recorded stream, is maintained in the recording storage 1155, while any earlier recorded data is discarded from the recording storage 1155.

The coded media bitstream is transferred from the recording storage 1155 to the decoder 1160. If there are many coded media bitstreams, such as an audio stream and a video stream, associated with each other and encapsulated into a container file, a file parser (not shown in the figure) is used to decapsulate each coded media bitstream from the container file. The recording storage 1155 or a decoder 1160 may comprise the file parser, or the file parser is attached to either recording storage 1155 or the decoder 1160.

The codec media bitstream is typically processed further by a decoder 1160, whose output is one or more uncompressed media streams. Finally, a renderer 1170 may reproduce the uncompressed media streams with a loudspeaker or a display, for example. The receiver 1150, recording storage 1155, decoder 1160, and renderer 1170 may reside in the same physical device or they may be included in separate devices.

Communication devices according to various embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

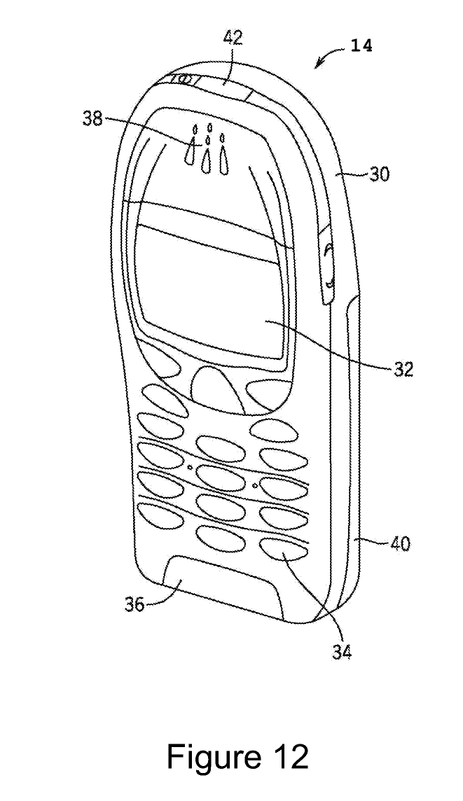

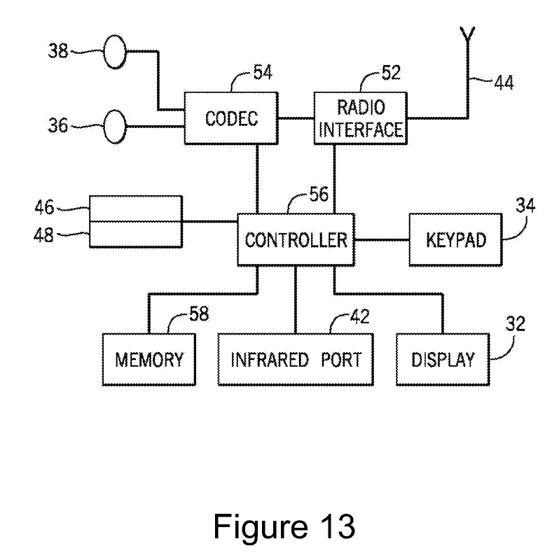

FIGS. 12 and 13 show one representative mobile device 14 within which the present invention may be implemented. It should be understood, however, that the present invention is not intended to be limited to one particular type of electronic device. The mobile device 14 of FIGS. 12 and 13 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

[The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
selecting a filter structure from a plurality of filter structures, the filter structure providing a maximal and minimal spatial support area;
calculating coefficient values of a filter based on the selected filter structure and prediction information indicative of a difference at least between a current frame and a reference frame;
encoding the coefficient values of the filter in a bitstream; and
signaling the filter structure in the bitstream.

2. The method of claim 1, wherein the plurality of filter structures comprise combinations of at least one of a directional filter structure and a radial filter structure.

3. The method of claim 2, wherein the directional filter structure further comprises at least one of a diagonal filter structure, and a diagonal cross filter structure.

4. The method of claim 1, wherein the plurality of filter structures comprise combinations of at least one of the filter structure with the maximal spatial support area and the minimal spatial support area for a given number of tap-length.

5. The method of claim 1, wherein the plurality of filter structures comprise combinations of at least one of a directional filter structure and a separable filter structure.

6. A computer-readable medium having a computer program stored thereon, the computer program comprising instructions operable to cause a processor to perform method of claim 1.

7. An apparatus, configured to:
select a filter structure from a plurality of filter structures, the filter structure providing a maximal and minimal spatial support area;
calculate coefficient values of a filter based on the selected filter structure and prediction information indicative of a difference at least between a current frame and a reference frame;
encode the coefficient values of the filter in a bitstream; and
signal the filter structure in the bitstream.

8. The apparatus of claim 7, wherein the plurality of filter structures comprise combinations of at least one of a directional filter structure and a radial filter structure.

9. The apparatus of claim 8, wherein the directional filter structure further comprises at least one of a diagonal filter structure, and a diagonal cross filter structure.

10. The method of claim 7, wherein the plurality of filter structures comprise combinations of at least one of the filter structure with the maximal spatial support area and the minimal spatial support area for a given number of tap-length.

11. The apparatus of claim 7, wherein the plurality of filter structures comprise combinations of at least one of a directional filter structure and a separable filter structure.

12. A method, comprising:
receiving in a bitstream, filter coefficient values and at least one signal representative of a filter structure selected from a plurality of filter structures for each of a plurality of samples interpolated from at least one of pixel and sub-pixel locations of a block representative of prediction information;
calculating a filter for each of the plurality of samples based on the received filter structure for each of the plurality of samples and the received filter coefficient values; and
reconstructing a prediction frame based on the prediction information and the plurality of samples.

13. The method of claim 12, wherein the plurality of filter structures comprise combinations of at least one of a directional filter structure and a radial filter structure.

14. The method of claim 13, wherein the directional filter structure further comprises at least one of a diagonal filter structure, and a diagonal cross filter structure.

15. The method of claim 12, wherein the plurality of filter structures comprise combinations of at least one of the filter structure with a maximal spatial support area and a minimal spatial support area for a given number of tap-length.

16. The method of claim 12, wherein the plurality of filter structures comprise combinations of at least one of a directional filter structure and a separable filter structure.

17. A computer-readable medium having a computer program stored thereon, the computer program comprising instructions operable to cause a processor to perform method of claim 12.

18. An apparatus, comprising a processor configured to:
receive in a bitstream, filter coefficient values and at least one signal representative of a filter structure selected from a plurality of filter structures for each of a plurality of samples interpolated from at least one of pixel and sub-pixel locations located between integer pixels of a block representative of prediction information;
calculate a filter for each of the plurality of samples based on the received filter structure for each of the plurality of samples and the received filter coefficient values; and
reconstruct a prediction frame based on the prediction information and the plurality of samples.

19. The apparatus of claim 18, wherein the plurality of filter structures comprise combinations of at least one of a directional filter structure and a radial filter structure.

20. The apparatus of claim 19, wherein the directional filter structure further comprises at least one of a diagonal filter structure, and a diagonal cross filter structure.

21. The apparatus of claim 18, wherein the plurality of filter structures comprise combinations of at least one of the filter structure with a maximal spatial support area and a minimal spatial support area for a given number of tap-length.

22. The apparatus of claim 18, wherein the plurality of filter structures comprise combinations of at least one of a directional filter structure and a separable filter structure.
